(19) United States
(12) Patent Application Publication
(10) Pub. No.: US 2006/0232730 A1
(43) Pub. Date: Oct. 19, 2006

(54) Filter for display apparatus and plasma display apparatus comprising filter

(75) Inventor: Ji-Hoon Sohn, Anyang-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/406,229

(22) Filed: Apr. 19, 2006

(30) Foreign Application Priority Data
Apr. 19, 2005 (KR) 10-2005-0032512

(51) Int. Cl. G02F 1/1333

(52) U.S. Cl. 349/110

(57) ABSTRACT

An improved structure of a filter for a display apparatus and a plasma display apparatus comprising the filter are provided. A filter for a display apparatus according to an embodiment of the present invention has a structure that forms directly on a single base film layer a multifunctional layer with a number of functions. Thus, this can reduce production cost, improve production throughput and improve efficiently functions of the filter for the display apparatus and the plasma display apparatus comprising the filter.

This Non-provisional application claims priority under 35 U.S.C. § 119(a) on Patent Application No. 10-2005-0032512 filed in Korea on Apr. 19, 2005 the entire contents of which are hereby incorporated by reference.

### BACKGROUND OF THE INVENTION

1. Field of the Invention

The document relates to a display apparatus, and more specifically, to a filter for a display apparatus and plasma display apparatus comprising the filter.

2. Description of the Related Art

In recently, as semiconductor technologies are rapidly improved, various electronics have a tendency to require lower and lower voltages and power consumptions, and become smaller, thinner, and lighter in their bodies, and accordingly, the demand for display apparatus is quickly increased as display apparatus suitable for the new environment.

A number of display apparatuses, for example, including plasma display apparatus, liquid crystal display, organic electroluminescence display apparatus, etc. have been developed accordingly. Of the display apparatuses, in particular, the plasma display apparatus is spotlighted as new generation display apparatus since it may be implemented in a large screen with thin thickness and light weight.

On the other hand, A display apparatus has unique optic property according to its kind and has a problem of reflective light generated by external light. Furthermore, A display apparatus has another problem that electromagnetic waves or near-infrared rays are radiated from the display surface of the display apparatus displaying.

To mitigate the above problems, a filter is formed over the display surface of the display apparatus. The filter is composed of a plurality of function layers, each of which solves the aforementioned problems, respectively. This filter is manufactured by a method where each function layer is formed on each base film layer, and then stacked using adhesives. Accordingly, there exist problems, such as the increase of the number of processes due to multiple function layer manufacturing processes and multiple stacking processes, lowering production throughput and the rise of production cost for the display apparatus.

### SUMMARY OF THE INVENTION

Accordingly, an object of the present invention is to solve at least the problems and disadvantages of the background art.

According to one aspect, there is provided a filter for a display apparatus comprising a base film layer and an anti-reflection layer formed on the base film layer, wherein the anti-reflection layer has at least one of a near-infrared ray blocking function or a color correction function.

According to another aspect, there is provided a filter for a display apparatus comprising a base film layer, an optic property layer formed directly on the base film layer, wherein the optic property layer has at least one of a near-infrared ray blocking function or a color correction function and an anti-reflection layer directly formed on the optic property layer.

According to still another aspect, there is provided a filter for a display apparatus comprising a base film layer, and an anti-glare layer formed directly on the base film layer, wherein the anti-glare layer has at least one of a near-infrared ray blocking function, a display light color correction function and an external light color correction function, the anti-glare layer directly.

According to one aspect, there is provided a plasma display apparatus comprising the filter.

The present invention can reduce production cost and improve production throughput and improve efficiently functions of a filter for a display apparatus and a plasma display apparatus including the filter.

### BRIEF DESCRIPTION OF THE DRAWINGS

The invention will be described in detail with reference to the following drawings in which like numerals refer to like elements.

FIG. 1 illustrates a filter for a display apparatus according to a first embodiment of the present invention.

FIG. 2 illustrates an anti-reflection layer according to a first embodiment of the present invention.

FIG. 3 illustrates another anti-reflection layer according to a first embodiment of the present invention.

FIG. 4 illustrates a manufacturing method of a filter according to a first embodiment of the present invention.

FIG. 5 illustrates a plasma display apparatus including a filter according to a first embodiment of the present invention.

FIG. 6 illustrates a filter for a display apparatus according to a second embodiment of the present invention.

FIG. 7 illustrates a plasma display apparatus including a filter according to a second embodiment of the present invention.

FIG. 8 illustrates a filter for a display apparatus according to a third embodiment of the present invention.

FIG. 9 illustrates a plasma display apparatus including a filter according to a third embodiment of the present invention.

### DETAILED DESCRIPTION OF PREFERRED EMBODIMENTS

Preferred embodiments of the present invention will be described in a more detailed manner with reference to the drawings.

A filter for a display apparatus according to a embodiment of the present invention comprises a base film layer and an anti-reflection layer formed on the base film layer, wherein the anti-reflection layer has at least one of a near infrared ray blocking function or a color correction function.

It is preferable that the anti-reflection layer comprises at least one of a near infrared ray blocking material or a color correction material.

It is preferable that the near infrared ray blocking material comprises at least one of a near infrared ray blocking pigment or a near infrared ray blocking dye.

It is preferable that the color correction material comprises at least one of a color correction pigment or a color correction dye.

It is preferable that the anti-reflection layer comprises a plurality of refraction layers having refractive indexes that are different from one another.

It is preferable that at least one of the plurality of refraction layers comprises at least one of the near infrared ray blocking material or the color correction material.

It is preferable that the color correction function comprises at least one of a display light color correction function or an external light color correction function.

It is preferable that the anti-reflection layer comprises a display light color correction material.

It is preferable that the display light color correction material comprises at least one of an amine-based dye, a sulfur-amine-based dye, a metal oxide pigment, and an organic pigment.

It is preferable that the anti-reflection layer comprises an external light color correction material.

It is preferable that the anti-reflection layer comprises a plurality of refraction layers and the external light color correction material varies depending on the number of the refraction layers.

It is preferable that the external light color correction material comprises at least one of a Co compound, a Fe compound, a Cr compound and a S compound.

It is preferable that the external light color correction material comprises a material that increases the reflectance of a predetermined wavelength of external light.

It is preferable that the wavelength ranges substantially from 500 nm to 600 nm.

It is preferable that the external light color correction material comprises Sb.

It is preferable that the external light color correction material comprises a mixture of V and Sn.

It is preferable that the external light color correction material comprises Pr.

It is preferable that the external light color correction material comprises a mixture of Zr and Cd.

It is preferable that the external light color correction material comprises a mixture of Cr and Ti.

It is preferable that the anti-reflection layer is formed directly on the base film layer.

It is preferable that the filter according to the first embodiment of the present invention further comprises an electromagnetic interference shielding layer for shielding electromagnetic waves.

It is preferable that the filter according to the first embodiment of the present invention further comprises an anti-glare layer for scattering external light.

A filter for a display apparatus according to a second embodiment of the present invention comprises a base film layer, an optic property layer formed directly on the base film, layer wherein the optic property layer has at least one of a near infrared ray blocking function or a color correction function and an anti-reflection layer formed directly on the optic property layer.

It is preferable that the color correction function comprises at least one of a display light color correction function or an external light color correction function.

It is preferable that the filter according to the second embodiment of the present invention further comprises an electromagnetic interference shielding layer for shielding electromagnetic waves.

A filter for a display apparatus according to a third embodiment of the present invention comprises a base film layer and an anti-glare layer formed directly on the base film layer, wherein the anti-glare layer has at least one of a near infrared ray blocking function, a display light color correction function, and an external light color correction function.

It is preferable that the anti-glare layer comprises a mixture layer comprising a first material forming the anti-glare layer itself and a second material, wherein the particle size of the second material is more than the particle size of the first material.

It is preferable that the filter according to the third embodiment of the present invention further comprises an electromagnetic interference shielding layer for shielding electromagnetic waves.

A plasma display apparatus according to an embodiment of the present invention comprises a filter according to an embodiment of the present invention.

It is preferable that the filter is a glass filter or a film filter.

Further detailed description of the other embodiments will be contained in the accompanying detailed description and drawings. The above and/or other aspects and advantages of the prevent invention will become apparent and more readily appreciated from the following description of the exemplary embodiments, taken in conjunction with the accompany drawings. Like reference numerals refer to like elements throughout.

### FIRST EMBODIMENT

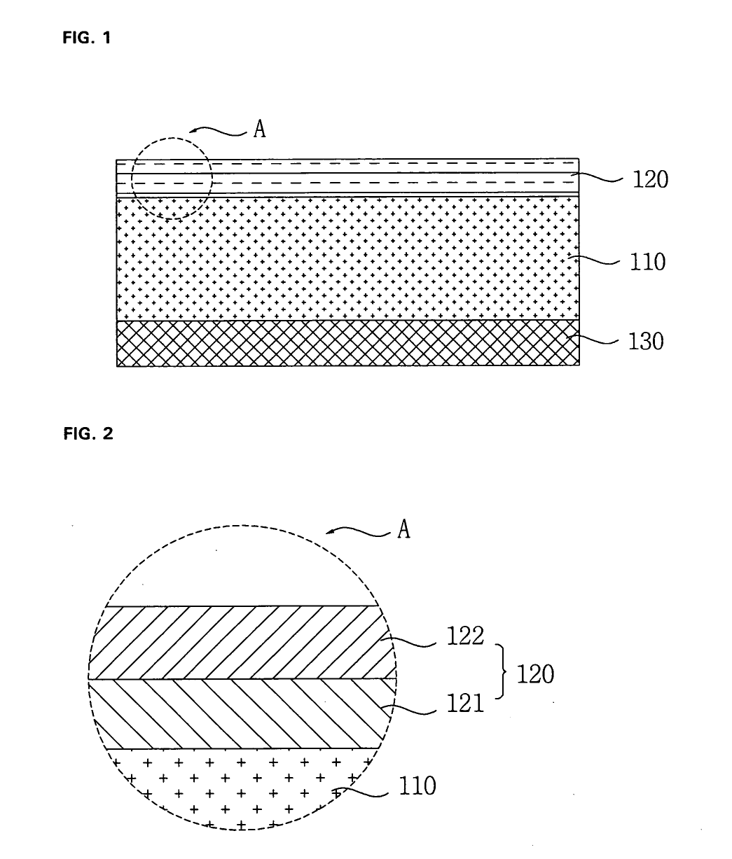

FIG. 1 illustrates a filter for a display apparatus according to a first embodiment of the present invention.

As shown in FIG. 1, a filter for a display apparatus according to a first embodiment of the present invention comprises a base film layer 110 and an anti-reflection layer 120.

The base film layer 110 serves as a base for forming the anti-reflection layer 120. The base film layer 110 is formed of PET(Poly ethylene terephthalate) film, TAC(Tantalum Carbide) film or the like.

The anti-reflection layer 120 is formed on the base film layer 110. The anti-reflection layer 120 has at least one of a near infrared ray blocking function or a color correction function.

The anti-reflection layer 120 comprises at least one of a near infrared ray blocking material or a color correction material to provide the near infrared ray blocking function or color correction function. At this time, it is desirable to use at least one of a near infrared ray blocking pigment or a near infrared ray blocking dye as the near infrared ray blocking material. Moreover, the color correction material employs at least one of a color correction pigment or a color correction dye.

Here, the present invention is not limited to the case where the near infrared ray blocking function or color correction function of the anti-reflection layer is implemented by adding the materials to the anti-reflection layer 120. For example, taking the fact into consideration that near infrared rays are blocked by a conductive film stacking structure and the like, the anti-reflection layer of the present invention may also have the near infrared ray blocking functions or correction function by varying its structure besides the material addition method.

As such, the filter according to the first embodiment of the present invention has a structure to include the anti-reflection layer 120 formed directly on one base film layer 110, and having the near infrared ray blocking function or color correction function, thus making it possible to reduce the number of production processes and to improve production throughput.

That is, since a separate function layer with the near infrared ray blocking function is not provided on another separate base film layer, and a separate function layer with the color correction function is not provided on another separate base film layer, either, the number of the function layer manufacturing processes and stacking processes can be lessened. Furthermore, it is possible to prevent the occurrence of defection arising from some cause such as entrance of unwanted substances in the procedure of stacking the respective function layers.

An adhesive layer 130 serves to attach to the display apparatus or to stack on other function layers the filter for the display apparatus according to the first embodiment of the present invention to the display apparatus.

In addition, the filter according to the first embodiment of the present invention further comprises an electromagnetic interference shielding layer. The electromagnetic interference shielding layer serves to prevent electromagnetic waves from being radiated from the display apparatus through a front surface thereof. The electromagnetic interference shielding layer employs either one of a mesh type where a conductive material is arranged on the base film layer in a mesh form, and a sputter type where a conductive layer is formed between two dielectric layers. Here, the electromagnetic interference shielding layer may be arranged on the rear surface of the base film layer 10, and also formed to be stacked on a separate base film layer. That is, the electromagnetic interference shielding layer of the filter according to the first embodiment of the present invention may be positioned at any place of the filter where it can be substantially formed and doesn't curtail other function layer's capability.

In addition, the filter according to the first embodiment of the present invention further comprises an anti-glare layer. The anti-glare layer serves to suppress the reflection of the external lights along with the anti-reflection layer 120. The anti-glare layer has a curved surface on which materials having different particle sizes mixed. This curved surface scatters the external light. Here, the anti-glare layer may be formed on the rear surface of the anti-reflection layer 120, and also formed to be stacked on a separate base film layer. That is, the anti-glare layer of the filter according to the first embodiment of the present invention may be positioned at any place of the filter where it can be substantially formed and doesn't curtail other function layer's capability.

FIG. 2 illustrates an anti-reflection layer according to a first embodiment of the present invention, which is an expanded view of region A of FIG. 1.

As shown in FIG. 2, the anti-reflection layer 120 according to the first embodiment of the present invention comprises a plurality of refraction layers having refractive indexes that are different from one another. The anti-reflection layer 120 according to the first embodiment of the present invention can provide the anti-reflection function by absorbing the external light through the plurality of refraction layers having the different refractive indexes.

The anti-reflection layer 120 has a structure that a first refraction layer 121 having a relatively high refractive index and a second refraction layer 122 having a relatively low refractive index are stacked on each other. The anti-reflection layer 120 constitutes one unit anti-reflection layer, which is comprised of the first refraction layer 121 and the second refraction layer 122, and, if necessary, it can have a structure that plural unit anti-reflection layers can be stacked on one another. The first refraction layer comprises TiO₂ or SnO₂, which has a refractive index of about 1.46. The second refraction layer comprises SnO₂, which has a refractive index of about 1.65.

In the first embodiment of the present invention, at least one refraction layer of the plurality of refraction layers comprises at least one of a near infrared ray blocking material or a color correction material to provide a near infrared ray blocking function or a color correction function.

For example, the first refraction layer 121 may contain the near infrared ray blocking material, and the second refraction layer 122 may contain the color correction material. In addition, the first refraction layer 121 may contain both of the near infrared ray blocking material and color correction material and the second refraction layer 122 may not contain both materials. In addition, the first refraction layer 121 and the second refraction layer 122 respectively may contain both of the materials. As such, the near infrared ray blocking material or color correction material may be added to the refraction layers in a number of cases as needed in the process of manufacturing the anti-reflection layer.

In addition, the anti-reflection layer 120 according to the first embodiment of the present invention has a display light color correction function. The display light color correction function is a function for correcting the color of display light generated upon driving a display apparatus. The display apparatus has its own unique display optic property according to its kind. The display optic property may be divided into two cases as follows.

It can be divided into one case where colors with a particular wavelength range are seen clearer than those with the other wavelength range and the other case where colors with a particular wavelength range are rarely recognized by human naked eyes compared to those with the other wavelength range. The one may correct colors by a method which reduces the external radiation of a specific wavelength range of light and the other may correct colors by a method which increases the external radiation of a specific wavelength of light.

The anti-reflection layer 120 according to the first embodiment of the present invention comprises a display light color correction material for the display light color correction. It is desirable to use at least one of amine-based dyes, sulfur-amine-based dyes, metal oxide pigments or organic pigments as the display light color correction material.

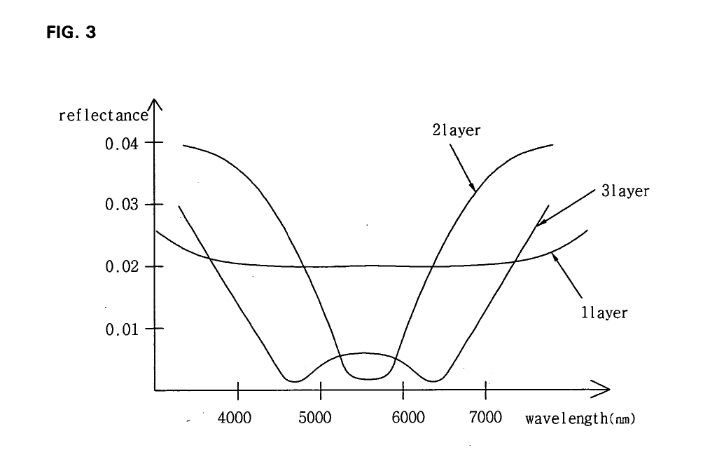

FIG. 3 illustrates another anti-reflection layer according to a first embodiment of the present invention.

As shown in FIG. 3, the anti-reflection layer according to the first embodiment of the present invention has different reflectance of external light corresponding to wavelength range according to the number of the unit anti-reflection layers. Therefore, the anti-reflection layer of the filter according to the first embodiment of the present invention is adapted to have the external light color correction function. The anti-reflection layer comprises an external light color correction material to provide the external light color correction function.

Since the reflectance of the external light corresponding to wavelength range varies with the number of refraction lays, i.e. the unit anti-reflection layers, the first embodiment of the present invention employs different external light color correction materials according to the number of the refraction layers. The anti-reflection layer is formed by doping and dispersing on an anti-reflection forming solution an inorganic pigment more stable than an organic pigment. For this purpose, the inorganic pigment uses at least one of a Co compound for yellow, green, light blue, purple, etc., an Fe compound for yellow, maroon, Prussian blue, etc., a Cr compound for green, yellow, etc. and a S compound for yellow, red, ultramarine, etc.

In addition, the first embodiment of the present invention uses as the external light color correction material a material that increases the reflectance of the predetermined wavelength of external light. That is, as the external light color correction material is employed one material for correcting colors of wavelength having relatively lower external light reflectance than the other wavelength.

In a case where two unit anti-reflection layers are used, since the external light reflectance is low in the wavelength of 500 nm to 600 nm, it is desirable to use pigments having relatively high reflectance in the wavelength of 500 nm to 600 nm. An inorganic pigment of making yellow color is used to increase the reflectance of the external light having the wavelength of 500 nm to 600 nm.

It is desirable to add Sb to the external light color correction material. That is, as the external light color correction material is used a material which is formed by making a solid solution of 2Pb—Sb₂O₅ pyrochroite type lattice and a compound such as Al₂O₃, Fe₂O₃, SnO₂. Further, it is desirable to add a mixture of V and Sn to the external light color correction material. That is, as the external light color correction material is used a material which is formed by making a solid solution of SnO₂ and V. Further, it is desirable to add Pr to the external light color correction material. That is, as the external light color correction material is used a material which is formed by making a solid solution of ZrSiO₄ and Pr. Further, it is desirable to add a mixture of Zr and Cd to the external light color correction material. That is, as the external light color correction material is used a material which is formed by making a solid solution of ZrSiO₄, and CdS or (CdZn)S. Further, it is desirable to add a mixture of Cr and Ti to the external light color correction material. That is, as the external light color correction material is used a material which is formed by making a solid solution of TiO₂, and CrSbO₄ or Cr₂WO₆. The first embodiment of the present invention may use each of the above materials separately and the mixture of at least two and more materials, too.

Therefore, the first embodiment of the present invention may reduce production cost of the filter for the display apparatus and also easily attain the color correction of the external light reflected by the filter.

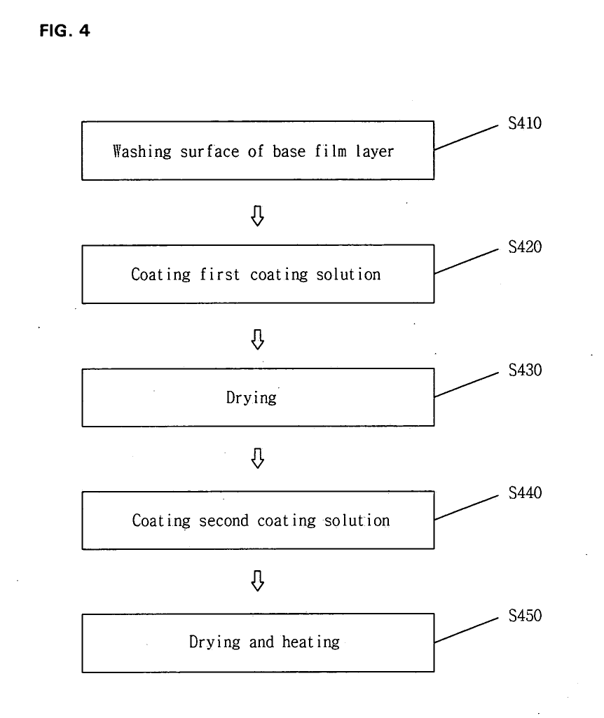

FIG. 4 illustrates a manufacturing method of a filter according to a first embodiment of the present invention.

Firstly, a base film layer is washed, on which an anti-reflection layer is to be formed, in the step (S410).

Then, on the upper side of the washed base film layer surface is coated with a first coating solution mixed of a material having a high refractive index and at least one of a color correction material or a near infrared ray blocking material, in the step (S420).

Next, the base film layer coated with the first coating solution is dried in the step (S430). Here, it is desirable that the drying temperature is about 50 □.

Then, on the upper side of the dried base film layer is coated with a second coating solution mixed of a material having a low refractive index and at least one of a color correction material or a near infrared ray blocking material, in the step (S440). At this time, the material included in the first coating solution of the color correction material and near infrared ray blocking material may be excluded from the second coating solution.

Then, the base film layer coated with the second coating solution is dried and heated in the step (S450), thus completing the filter according to the first embodiment of the present invention. It is desirable that the heating temperature ranges from 150 □ to 400 □.

As such, simplifying the filter structure allows for lowering production cost, decreasing the occurrence of poor product due to unwanted substances' entrance, and attaining color correction readily.

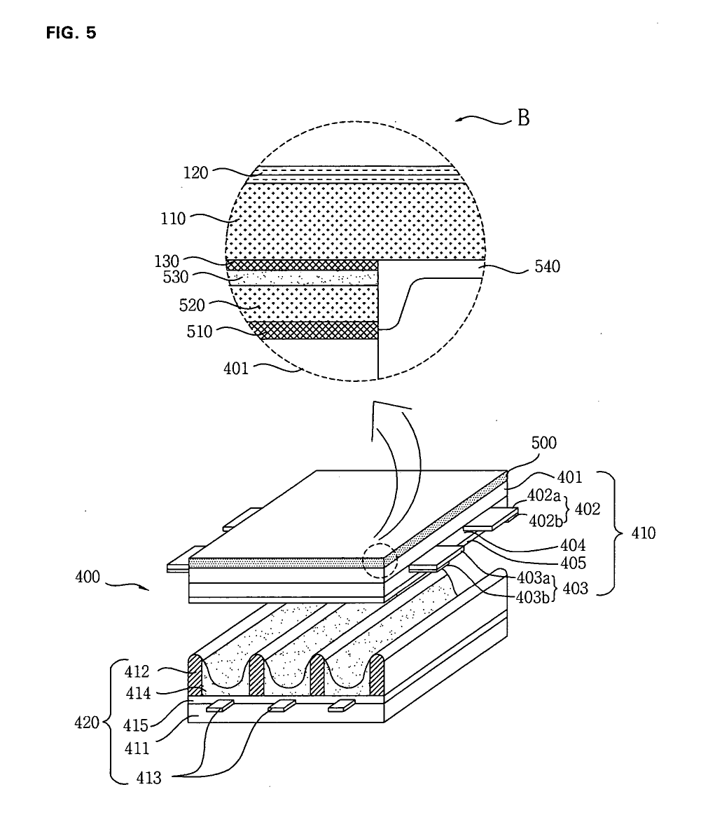

FIG. 5 illustrates a plasma display apparatus including a filter according to a first embodiment of the present invention.

As shown in FIG. 5, a plasma display apparatus according to a first embodiment of the present invention comprises a plasma display panel 400 and a filter 500 formed on the plasma display panel.

The plasma display panel 400 comprises a front panel 410 and a rear panel 420 which are coupled in parallel to be opposed to each other at a given distance therebetween. The front panel 400 comprises a front substrate 401 being a display surface on which an image is displayed, and the rear panel 420 comprises a rear substrate 411 being a rear surface. A plurality of scan electrodes 402 and a plurality of sustain electrodes 403 are formed in pairs on the front substrate 401 to form a plurality of sustain electrode pairs. A plurality of address electrodes 413 are formed on the rear substrate 411 to intersect the plurality of sustain electrode pairs

The front panel 410 comprises a pair of a scan electrode 402 and a sustain electrode 403, wherein the scan electrode 402 and the sustain electrode 403 are composed of transparent electrodes 402a, 403a and bus electrodes 402b, 403b. The scan electrode 402 and sustain electrode 403 are covered by an upper dielectric layer 404, on which a protective layer 405 is formed.

The rear panel 420 comprises barrier ribs 412 for defining discharge cells. In addition, a plurality of address electrodes 413 are arranged in parallel with the barrier ribs 412. On the address electrodes 413 are applied a R(red), G(green), and B(blue) phosphor 414. A lower dielectric layer 415 is formed between the address electrodes 413 and phosphor 414. FIG. 4 shows an example of a plasma display panel's structure, and the electrode's structure or barrier rib's structure may be varied, if necessary.

A barrier rib 412 formed between the front panel 410 and the rear panel 420 in the plasma display panel 400 constitutes one unit cell. Each cell is filled with an inert gas containing a main discharge gas such as neon (Ne), helium (He) or a Ne—He gas mixture, and a small amount of xenon (Xe). When a high frequency voltage generates a discharge of the inert gas, the discharge of the inert gas emits vacuum ultraviolet rays. The phosphor 414 formed between the barrier ribs 412 emits visible light by vacuum ultraviolet rays to display images.

On the rear surface of the plasma display panel 400 which displays images are assembled a frame, a driving apparatus(not shown), and the like, to thereby form a plasma display module. Then, the addition of a case(not shown), which defines the outline, to the plasma display module completes the plasma display apparatus.

Since the plasma display apparatus as configured above displays images by applying high frequencies to generate plasma discharges, it emits more electromagnetic waves through its display surface than color CRT or liquid crystal display. Moreover, the plasma display apparatus radiates near infrared rays induced by the inert gas such as Ne, Xe, and the like, which may, in turn, cause mal-operation. Since the wavelength of the near infrared rays of the plasma display apparatus is very similar to the wavelength of the near infrared rays of remote controllers of home appliances. In addition, the plasma display apparatus is characterized by emitting orange color wavelength range of rays more than other display apparatus in accordance with the properties of the phosphor.

Accordingly, the plasma display apparatus according to the first embodiment of the present invention provides on the plasma display panel 400 the filter as shown in FIGS. 1 to 4 according to the first embodiment of the present invention. A structure of the filter provided in the display apparatus according to the first embodiment of the present invention will be described below in more detail with reference to region B of FIG. 5, which is a sectional view of the plasma display apparatus. The filter 500 for the plasma display apparatus comprises a first adhesive layer 510 for attaching the filter 500 to the front substrate 401 of the plasma display panel, a first base film layer 520 formed on the first adhesive layer 510 and for providing an electromagnetic interference shielding layer 530, the electromagnetic interference shielding layer 530 formed on the first base film layer 520 and for shielding electromagnetic waves radiated outward upon driving the plasma display apparatus and a grounding member 540 for grounding the electromagnetic interference shielding layer 530 to the external earth terminal.

In addition, the filter 500 for the plasma display apparatus comprises a second adhesive layer 130 for attaching a second base film layer 110 on the electromagnetic interference shielding layer 530, the second base film layer 110 formed on the second adhesive layer 130 and for providing an anti-reflection layer 120, and the anti-reflection layer 120 formed on the second base film layer 110 and for providing at least one of a near infrared ray blocking function or a color correction function.

The characteristic regarding the structure and manufacturing method of the filter has been sufficiently described with reference to FIGS. 1 to 4, and its detailed description will now be omitted.

As such, the plasma display apparatus according to the first embodiment of the present invention has the filter for the plasma display apparatus according to the first embodiment of the present invention, and this allows for attaining more efficient electromagnetic wave shielding effect compared to other display apparatus. In addition, this can improve production throughput, and reduce production cost.

On the other hand, the filter according to the first embodiment of the present invention may also be formed in a film-filter type or glass-filter type. The filter type is classified in accordance with how the filter is configured on the plasma display panel. The film-filter type is a type where, as in FIG. 5, the filter 500 is attached directly to the plasma display panel 400, and the glass-filter type is a type where the filter 500 is attached on a given glass substrate spaced from the plasma display panel 400.

The filter for the plasma display apparatus according to the first embodiment of the present invention doesn't provide separate function layers to improve various functions of the display apparatus but instead provides a single base film layer formed with the function layers. In particular, the filter used for the plasma display apparatus requires further diverse functions for its own in comparison with the filter used for other display apparatus. Therefore, the filter for the plasma display apparatus according to the first embodiment of the present invention is used for the plasma display apparatus, and this can provide sufficiently effects such as improving production efficiency, and reducing production cost of the plasma display apparatus.

### SECOND EMBODIMENT

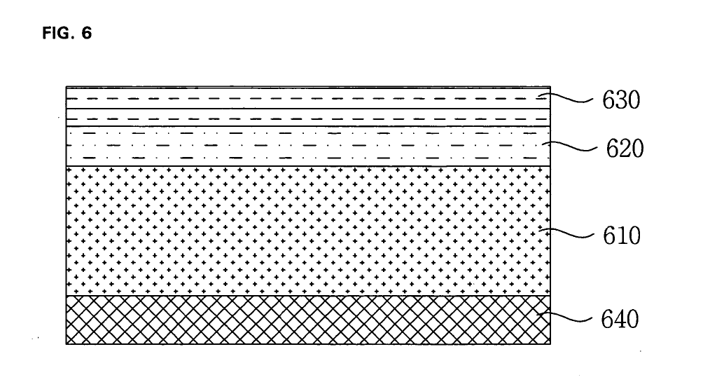

FIG. 6 illustrates a filter for a display apparatus according to a second embodiment of the present invention.

As shown in FIG. 6, a filter for a display apparatus according to a second embodiment of the present invention comprises a base film layer 610, an optic property layer 620 and an anti-reflection layer 630.

The filter according to the second embodiment of the present invention, in contrast to the filter according to the first embodiment of the present invention, has a private optic property layer 620, which provides a near infrared ray blocking function or color correction function, wherein the anti-reflection layer 630 does not provide the near infrared ray blocking function and color correction function. The optic property layer 620 has at least one of a display light color correction function or an external light color correction function. In addition, the optic property layer 620 is formed to contain at least one of a near infrared ray blocking material or a color correction material.

As such, the second embodiment of the present invention has a filter structure to be composed of the base film layer 610, the optic property layer 620 formed directly on the base film layer 610, and the anti-reflection layer 630 formed directly on the optic property layer 620, thus making it possible to reduce the number of production processes, and to improve production throughput. That is, since a single base film layer is used, its structure is simplified. Whereas a process for providing the optic property layer separately is needed, the process for adding the near infrared ray blocking material or color correction material to the anti-reflection layer is not necessary.

The filter according to the second embodiment of the present invention also comprises an adhesive layer 640. In addition, this may also comprise an electromagnetic interference shielding layer or anti-glare layer. As such, the filter according to the second embodiment of the present invention may also have the characteristics relating to the filter according to the first embodiment of the present invention, for example, the kinds of the near infrared ray blocking material and color correction material, the manufacturing method of the filter, etc. except the characteristic relating to the optic property layer. Of the characteristics of the filter according to the second embodiment of the present invention, substantially the same characteristics as those of the filter according to the first embodiment of the present invention have been sufficiently described above with reference to FIGS. 1 to 4, and the detailed description will now be omitted.

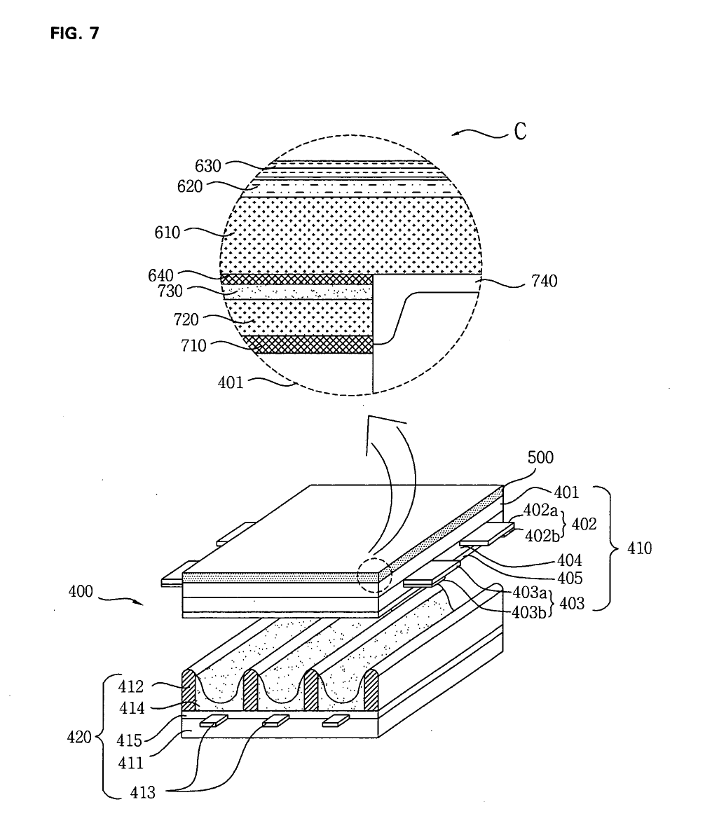

FIG. 7 illustrates a plasma display apparatus including a filter according to a second embodiment of the present invention.

As shown in FIG. 7, a plasma display apparatus according to a second embodiment of the present invention comprises a plasma display panel 400 and a filter 700 formed on the plasma display panel.

A structure of the filter 700 provided in the plasma display apparatus according to the second embodiment of the present invention will be described below in more detail with reference to region C of FIG. 7, which is a sectional view of the plasma display apparatus. The filter 700 for the plasma display apparatus comprises a first adhesive layer 710 for attaching the filter 700 to the front substrate 401 of the plasma display panel, a first base film layer 720 formed on the first adhesive layer 710 and for providing an electromagnetic interference shielding layer 730, the electromagnetic interference shielding layer 730 formed on the first base film layer 720 and for shielding electromagnetic wave radiated outward upon driving the plasma display apparatus and a grounding member 740 for grounding the electromagnetic interference shielding layer 730 to the external earth terminal.

In addition, the filter 700 for the plasma display apparatus comprises a second adhesive layer 640 for attaching a second base film layer 610 on the electromagnetic interference shielding layer 730, the second base film layer 610 formed on the second adhesive layer 640 and for providing an optic property layer 620, the optic property layer 620 formed on the second base film layer 610 and for providing at least one of a near infrared ray blocking function or a color correction function, and an anti-reflection layer 630 formed on the optic property layer 620.

Of the characteristics and effects of the plasma display apparatus according to the second embodiment of the present invention, the detailed description of substantially the same characteristics and effects as those of the plasma display apparatus according to the first embodiment and the filter according to the second embodiment of the present invention described with reference to FIGS. 1 to 6 will now be omitted.

As such, the plasma display apparatus according to the second embodiment of the present invention has the filter for the plasma display apparatus according to the second embodiment of the present invention, and this allows for improving production throughput and saving production cost.

### THIRD EMBODIMENT

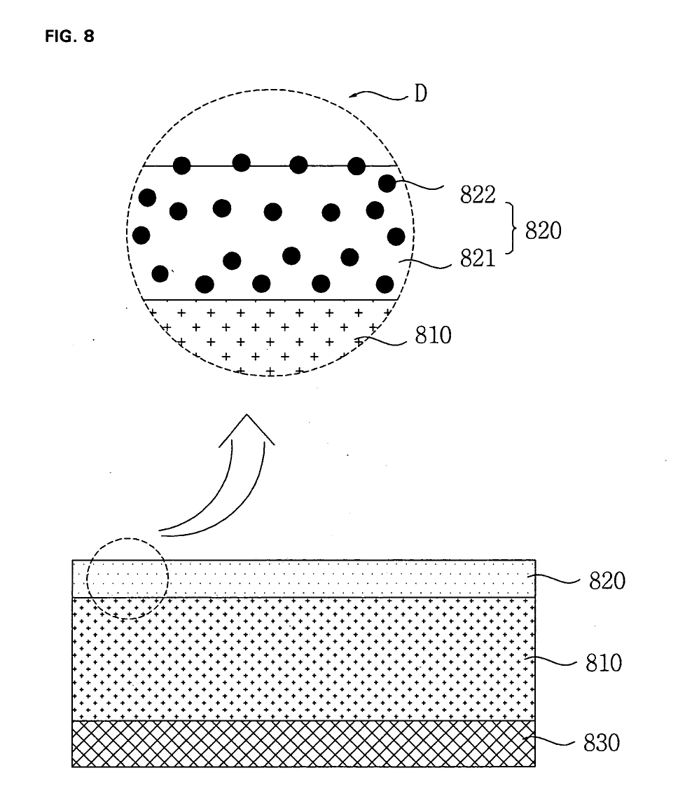

FIG. 8 illustrates a filter for a display apparatus according to a third embodiment of the present invention.

As shown in FIG. 8, a filter for a display apparatus according to a third embodiment of the present invention comprises a base film layer 810 and an anti-glare layer 820.

The filter according to the third embodiment of the present invention, in contrast to the filter according to the first and second embodiments of the present invention, comprises the anti-glare layer 820 having a near infrared ray blocking function, a display light color correction function or an external light color correction function. As shown in region D of FIG. 8, the anti-glare layer 820 comprises a mixture layer comprising a first material 821 of forming the anti-glare layer itself, and a second material 822 the particle size of the second material is more than the particle size of the first material. Therefore, the anti-glare layer 820 creates unevenness on its surface. This unevenness serves to scatter the external light and suppress the reflection of the external light. In the mixture layer is contained at least one of a near infrared ray blocking material, a display light color correction material or an external light color correction material.

As such, the third embodiment of the present invention has a filter structure to be composed of the base film layer 810, the anti-glare layer 820 formed directly on the base film layer 810. Thus, making it possible to reduce the number of production processes and to improve production throughput. That is, since a single base film layer is used, its structure is simplified.

The filter according to the third embodiment of the present invention also comprises an adhesive layer 830. In addition, this may further comprise an electromagnetic interference shielding layer or an anti-reflection layer. As such, the filter according to the third embodiment of the present invention may also have the characteristics relating to the filter according to the first embodiment of the present invention, for example, the kinds of the near infrared ray blocking material and color correction material, the manufacturing method of the filter, etc. except the characteristic relating to the anti-glare layer. Also, it is possible to embody a new filter for a display apparatus from the second and third embodiments, which comprises a base film layer, an optic property layer and an anti-glare layer. Of the characteristics of the filter according to the third embodiment of the present invention, substantially the same characteristics as those of the filter according to the first and second embodiments of the present invention have been sufficiently described above with reference to FIGS. 1 to 4, and FIG. 6, and the detailed description will now be omitted.

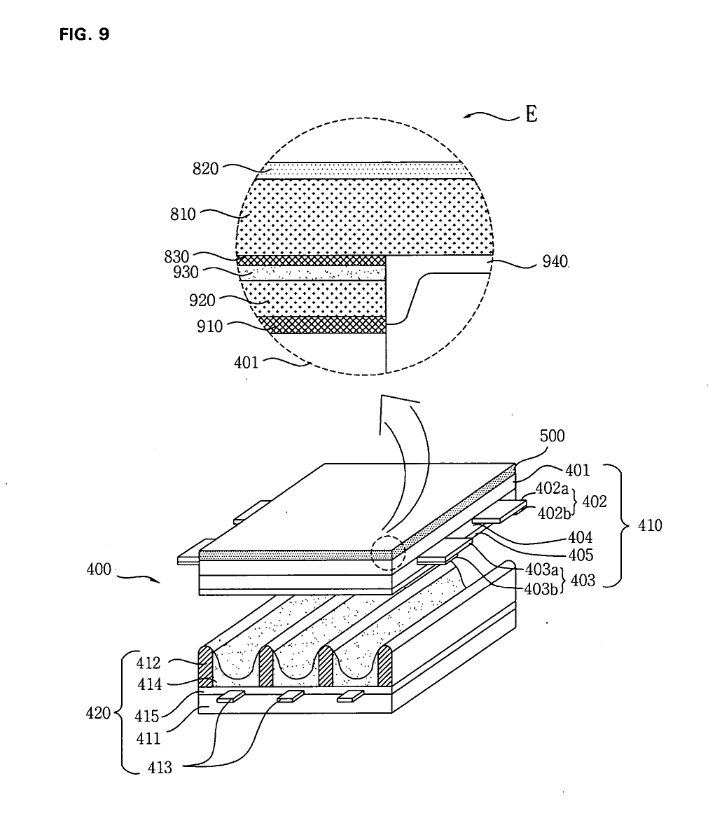

FIG. 9 illustrates a plasma display apparatus including a filter according to a third embodiment of the present invention.

As shown in FIG. 9, a plasma display apparatus according to a third embodiment of the present invention comprises a plasma display panel 400 and a filter 900 formed on the plasma display panel.

A structure of the filter 900 provided in the plasma display apparatus according to the third embodiment of the present invention will be described below in more detail with reference to region E of FIG. 9, which is a sectional view of the plasma display apparatus. The filter 900 for the plasma display apparatus comprises a first adhesive layer 910 for attaching the filter 900 to the front substrate 401 of the plasma display panel, a first base film layer 920 formed on the first adhesive layer 910 and for providing an electromagnetic interference shielding layer 930, the electromagnetic interference shielding layer 930 formed on the first base film layer 920 and for shielding electromagnetic wave radiated outward upon driving the plasma display apparatus and a grounding member 940 for grounding the electromagnetic interference shielding layer 930 to the external earth terminal.

In addition, the filter 900 for the plasma display apparatus comprises a second adhesive layer 830 for attaching a second base film layer 810 on the electromagnetic interference shielding layer 930, the second base film layer 810 formed on the second adhesive layer 830 and for providing an anti-glare layer 820 and the anti-glare layer 820 formed on the second base film layer 810 and for providing at least one of a near infrared ray blocking function, a display light color correction function, or an external light color correction function.

Of the characteristics and effects of the plasma display apparatus according to the third embodiment of the present invention, the same descriptions as those described with reference to FIGS. 1 to 8 will now be omitted to avoid repetition.

As such, a plasma display apparatus according to an embodiment of the present invention has a filter for a plasma display apparatus according to an embodiment of the present invention, and this allows for improving production throughput and saving production cost.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A filter for a display apparatus comprising:
a base film layer; and
an anti-reflection layer formed on the base film layer, wherein the anti-reflection layer has at least one of a near infrared ray blocking function or a color correction function.

2. The filter of claim 1, wherein the anti-reflection layer comprises at least one of a near infrared ray blocking material or a color correction material.

3. The filter of claim 2, wherein the near infrared ray blocking material comprises at least one of a near infrared ray blocking pigment or a near infrared ray blocking dye.

4. The filter of claim 2, wherein the color correction material comprises at least one of a color correction pigment or a color correction dye.

5. The filter of claim 1, wherein the anti-reflection layer comprises a plurality of refraction layers having refractive indexes that are different from one another.

6. The filter of claim 5, wherein at least one of the plurality of refraction layers comprises at least one of the near infrared ray blocking material or the color correction material.

7. The filter of claim 1, wherein the color correction function comprises at least one of a display light color correction function or an external light color correction function.

8. The filter of claim 7, wherein the anti-reflection layer comprises a display light color correction material.

9. The filter of claim 8, wherein the display light color correction material comprises at least one of an amine-based dye, a sulfur-amine-based dye, a metal oxide pigment or an organic pigment.

10. The filter of claim 7, wherein the anti-reflection layer comprises an external light color correction material.

11. The filter for a display apparatus of claim 10, wherein the anti-reflection layer comprises a plurality of refraction layers and the external light color correction material varies depending on the number of the refraction layers.

12. The filter of claim 10, wherein the external light color correction material comprises at least one of a Co compound, a Fe compound, a Cr compound and a S compound.

13. The filter of claim 10, wherein the external light color correction material comprises a material that increases the reflectance of a predetermined wavelength of external light.

14. The filter of claim 13, wherein the wavelength ranges substantially from 500 nm to 600 nm.

15. The filter of claim 14, wherein the external light color correction material comprises Sb.

16. The filter of claim 14, wherein the external light color correction material comprises a mixture of V and Sn.

17. The filter of claim 14, wherein the external light color correction material comprises Pr.

18. The filter of claim 14, wherein the external light color correction material comprises a mixture of Zr and Cd.

19. The filter of claim 14, wherein the external light color correction material comprises a mixture of Cr and Ti.

20. The filter of claim 1, wherein the anti-reflection layer is formed directly on the base film layer.

21. The filter of claim 1, further comprising an electromagnetic interference shielding layer for shielding electromagnetic waves.

22. The filter of claim 1, further comprising an anti-glare layer for scattering external light.

23. A filter for a display apparatus comprising:
a base film layer;
an optic property layer formed directly on the base film layer, wherein the optic property layer has at least one of a near infrared ray blocking function or a color correction function; and
an anti-reflection layer formed directly on the optic property layer.

24. The filter of claim 23, wherein the color correction function comprises at least one of a display light color correction function or an external light color correction function.

25. The filter of claim 23, further comprising an electromagnetic interference shielding layer for shielding electromagnetic waves.

26. A filter for a display apparatus comprising:
a base film layer; and
an anti-glare layer formed directly on the base film layer, wherein the anti-glare layer has at least one of a near infrared ray blocking function, a display light color correction function and an external light color correction function.

27. The filter of claim 26, wherein the anti-glare layer comprises a mixture layer comprising a first material forming the anti-glare layer itself and a second material, wherein the particle size of the second material is more than the particle size of the first material.

28. The filter of claim 26, further comprising an electromagnetic interference shielding layer for shielding electromagnetic waves.

29. A plasma display apparatus comprising the filter of claim 26.

30. The plasma display apparatus of claim 29, wherein the filter is a glass filter or a film filter.
